(19) United States
(12) Patent Application Publication
(10) Pub. No.: US 2017/0308830 A1
(43) Pub. Date: Oct. 26, 2017

(54) HAPPINESS INDICATOR SYSTEM

(71) Applicant: Albert Navarra, Newport Beach, CA (US)

(72) Inventor: Albert Navarra, Newport Beach, CA (US)

(21) Appl. No.: 15/135,050

(22) Filed: Apr. 21, 2016

(51) Int. Cl. G06Q 10/06; G06Q 10/10

(52) U.S. Cl. CPC G06Q 10/0639; G06Q 10/105

(57) ABSTRACT

A system that gives an employer a happiness indicator assessment that reflects a job applicant test taker's level of happiness. A server computer is programmed to receive communications from an employer and a test taker. The server computer has at least one happiness indicator test and programming to score a completed happiness indicator test. An employer computer is connected to the server computer via the Internet. Utilizing the employer computer, an employer can transmit to the server computer the employer's membership information and purchase orders for happiness indicator tests. The employer can receive the results of happiness indicator tests at the employer computer. A test taker computer is connected to the server computer via the Internet. The test taker computer is programmed to receive a happiness indicator test from said server computer and transmit to the server computer answers for questions included on said happiness indicator test. In a preferred embodiment, the results of the completed happiness indicator test are utilized by the employer to decide whether to hire the test taker.

The present invention relates to systems for providing reports on human conditions, and in particular to systems for providing reports on human emotional conditions.

### BACKGROUND OF THE INVENTION

### Employee Happiness

It is well recognized that it is generally to the benefit of an employer to have happy and content employees. Happy employees strongly contribute to a positive work environment. This creates more satisfied workers, increases productivity and enhances the organization's profits and bottom line.

It is the continuing challenge of the employer to foster general happiness at the workplace for the benefit of his employees and the overall productivity of the business. Part of the employer's responsibility is to conduct business in such a way so that the employees are motivated and happy. This becomes easier and more efficient it the employer is able to effective hire people who by nature have a good, pre-existing healthy attitude and are generally happy. It currently is often difficult, however, to easily and quickly determine a job applicant's level of happiness.

### Workers' Compensation Insurance

Workers' Compensation is a form of insurance providing wage replacement and medical benefits to employees injured in the course of employment in exchange for mandatory relinquishment of the employee's right to sue his or her employer for the tort of negligence. Workers' Compensation Insurance can be very expensive for an employer. Moreover, insurance rates can increase if it becomes apparent that a particular employer is a bad risk with unusually high claims. It is therefore to the advantage and benefit of the employer to conduct his business in such a way as to minimize Worker's Compensation claims. It is further recognized that happy employees are less likely to file a Workers' Compensation claim than unhappy employees.

What is needed is a system that allows an employer to determine easily and quickly a job applicant's level of happiness prior to hiring the job applicant.

### SUMMARY OF THE INVENTION

The present invention provides a system that gives an employer a happiness indicator assessment that reflects a job applicant test taker's level of happiness. A server computer is programmed to receive communications from an employer and a test taker. The server computer has at least one happiness indicator test and programming to score a completed happiness indicator test. An employer computer is connected to the server computer via the Internet. Utilizing the employer computer, an employer can transmit to the server computer the employer's membership information and purchase orders for happiness indicator tests. The employer can receive the results of happiness indicator tests at the employer computer. A test taker computer is connected to the server computer via the Internet. The test taker computer is programmed to receive a happiness indicator test from said server computer and transmit to the server computer answers for questions included on said happiness indicator test. In a preferred embodiment, the results of the completed happiness indicator test are utilized by the employer to decide whether to hire the test taker.

### BRIEF DESCRIPTION OF THE DRAWINGS

FIG. 1 shows a preferred embodiment of the present invention.

FIG. 2 depicts a flowchart outlining a preferred embodiment of the present invention.

FIGS. 3-8 depict preferred web site programming.

FIG. 9 depicts a preferred report summarizing the results of a completed happiness indicator test.

### DETAILED DESCRIPTION OF THE PREFERRED EMBODIMENTS

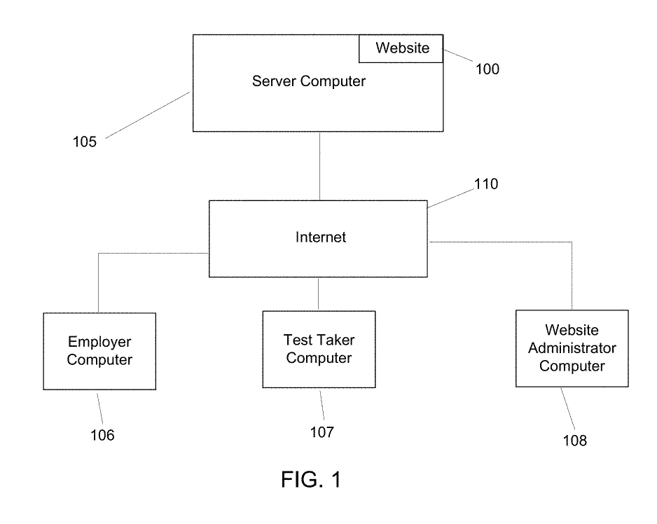

FIG. 1 shows a preferred embodiment of the present invention. The system shown in FIG. 1 allows for a prospective employee (also known as the Test Taker) to take a test via a communication network (such as the Internet 110) to determine the test taker's level of happiness. Website 100 is loaded onto server computer 105.

In a preferred embodiment, an employer utilizing employer computer 106 accesses website 100 via the Internet. The employer opens an account which grants him access to one or more tests that he can give to perspective job applicants. The tests provide an assessment that determines the level of happiness of the job applicant. The employer can then utilize the happiness assessment information when deciding if he should hire the job applicant.

In a preferred embodiment, the employer directs the job applicant test taker to take the happiness determination test. Utilizing test taker computer 107, the job applicant test taker preferably accesses the test at website 100 via the Internet. After completing the test the results of the test are transmitted via the Internet to Employer. The test results will provide the employer with an assessment of the test taker's happiness level. The employer then may utilize the assessment of the test taker's happiness level as a factor in deciding whether to hire the job applicant. In most cases, the employer will want to hire people who have a high happiness rating. Employees who are happy are less likely to file a worker's compensation claim than workers who are unhappy. In a preferred embodiment, a website administrator can monitor the above described process by utilizing website administrator computer 108.

### The Website

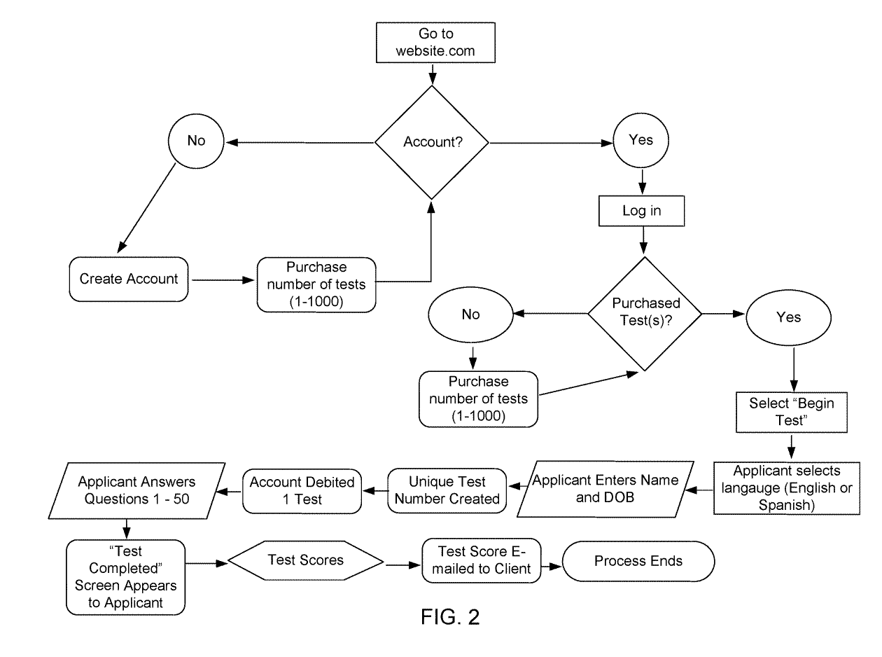

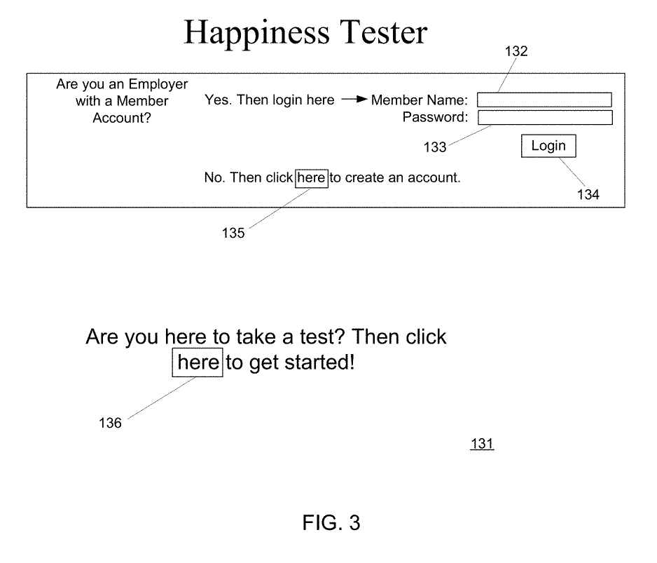

In a preferred embodiment of the present invention, website 100 is loaded onto server computer 105. Website 100 includes programming outlined by the flowchart depicted in FIG. 2 and described in greater detail in FIGS. 3-8.

In FIG. 3, an employer at employer computer 106 accesses website 100 via the Internet and views home page 131. If the employer is already has an account he will enter his account membership information (such as his member name and password) into block 132 and 133 and then click login button 134 to login. If the employer is not a member, then he will click button 135 to create an account. After the member has created an account he will be able to login as described.

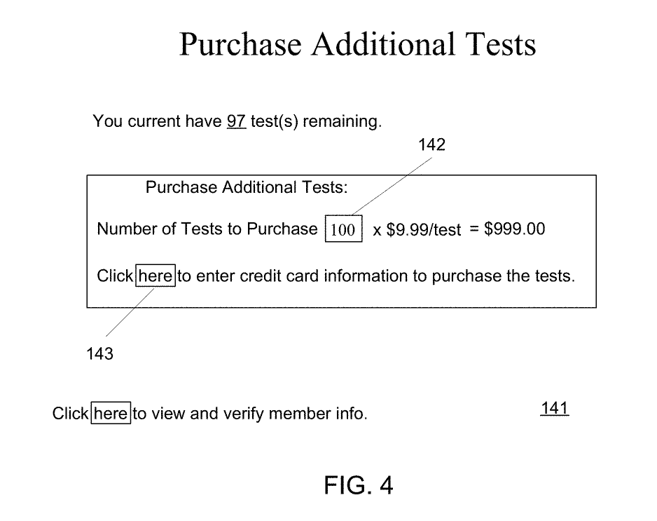

In FIG. 4, the employer has logged into his account and is at webpage 141. He is presented with a message that informs him that he currently has “97” tests remaining. If the employer wishes the purchase additional tests he indicates the number of tests he would like in box 142 and then clicks on button 143 to enter credit card information and purchase the tests. In FIG. 4 the employer has opted to purchase 100 additional tests.

The employer may now direct current job applicants to take one of the tests to determine happiness. For example, the employer may provide a job applicant with the web site address information so that the job applicant can view web page 131 (FIG. 3) on test taker computer 107 (FIG. 1). The job applicant test taker will then click on button 136 to begin taking a test.

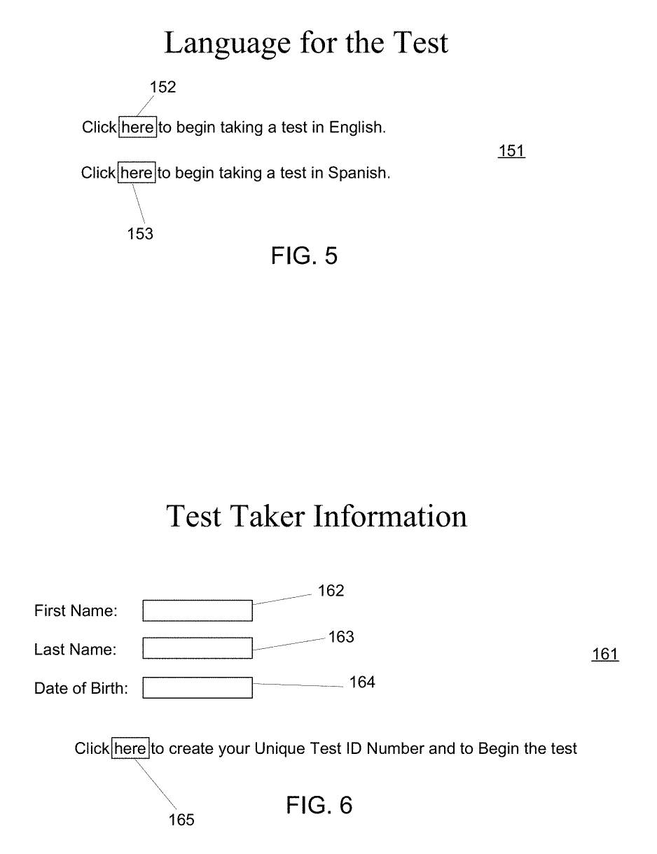

In FIG. 5, the test taker has clicked on button 136 and has been directed to web page 151. The test taker can then choose a language for the test. He may click on button 152 to take the test in English or button 153 to take the test in Spanish.

In FIG. 6, the test taker has clicked on button 152 (FIG. 5) and has been directed to page 161. The test taker may now enter his first name, last name and date of birth in boxes 162-164. The test taker then may click on button 165 to create a unique Test ID number and begin the test.

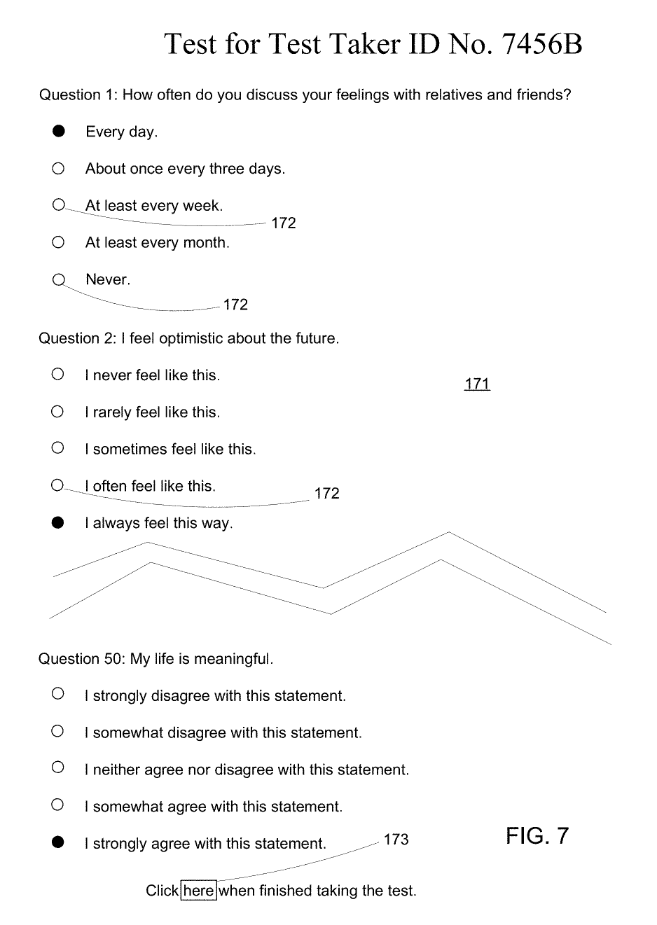

In FIG. 7, the test taker has clicked on button 165 (FIG. 6) and has been directed to web page 171 and assigned a Test Taker ID Number. On web page 171 there is a fifty question happiness indicator test that includes questions carefully worded to access the test taker's level of happiness. In one preferred embodiment, each question has a selection of five answers. To choose an answer the test taker clicks on one circle 172 per question. When the test taker is finished, he clicks on button 173.

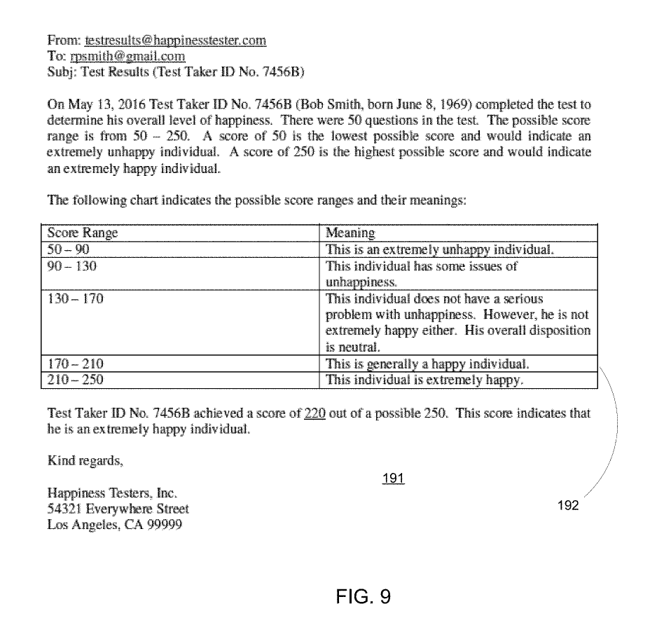

In a preferred embodiment, each possible answer has a weighted value that reflects the level of happiness of the test taker. For example, Question 2 a statement that states, “I feel optimistic about the future.” An answer of “I never feel like this” is assigned a value of “1”. An answer of, “I rarely feel like this” is assigned a value of 2. An answer of “I sometimes feel like this” is assigned a value of 3. An answer of “I often feel like this” is assigned a value of “4”. An answer of “I always feel this way” is assigned a value of “5”. If the value of the answer is high, then so is the happiness of the test taker. At the end of the 50 question test, all answer values are added. For example, table 192 (FIG. 9) shows a preferred example of score ranges and their meanings for a test taker. A very high score indicates a very happy test taker. Conversely a very low score indicates a very unhappy test taker.

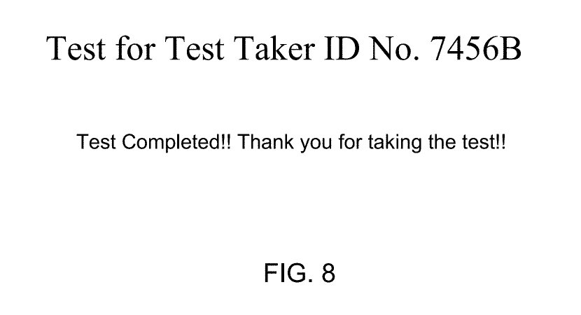

In FIG. 8, the user has clicked on button 173 (FIG. 7). A statement is displayed that indicates that he is finished with the test and he is thanked for taking the test.

In a preferred embodiment, after the test is completed a report summarizing the results of the test is sent via email from website 100 to the employer at employer computer via the Internet. For example, FIG. 9 shows email 191 which summarizes the results of the test for Test Taker 7456B. The email states, “Test Taker ID No. 7456B achieved a score of 220 out of a possible 250. This score indicates that he is an extremely happy individual.”

In a preferred embodiment an administrator at administrator computer 108 monitors web site 100 and communications from employer computer 106 and test taker computer 107. The administrator may answer questions transmitted from employer computer 106 and test taker computer 107. He may also respond to complaints and manage accounts.

After receiving email 191, the employer has an extremely valuable tool to use in deciding whether to hire the job applicant test taker. While there may be other factors to consider when deciding who to hire, the general happiness level of the potential employee is a very important consideration.

Although the above-preferred embodiments have been described with specificity, persons skilled in this art will recognize that many changes to the specific embodiments disclosed above could be made without departing from the spirit of the invention. For example, even though FIG. 1 shows the utilization of employer computer 106 and test taker computer 107, it would be possible for both the employer and test taker share the same computer. Therefore, the attached claims and their legal equivalents should determine the scope of the invention.

What is claimed is:

1. A system for providing an employer with a happiness assessment regarding a job applicant test taker, comprising:
A. a server computer programmed to receive communication from an employer and a test taker, said server computer comprising at least one happiness indicator test,
B. an employer computer connected via the Internet to said server computer, said employer computer being programmed to:
1) transmit to said server computer the employers account membership information and purchase orders for said at least one happiness indicator test, and
2) receive from said server computer communication summarizing the results of said happiness indicator test taken by the test taker,
C. a test taker computer connected via the Internet to said server computer, said test taker computer being programmed to:
1) receive from said server computer said happiness indicator test, and
2) transmit to said server computer answers to questions located on said happiness indicator test,
wherein said results of said happiness indicator test is utilized by the employer in deciding whether to hire the test taker.

2. The system as in claim 1 further comprising an administrator computer connected to said server computer via the Internet for monitoring said employee computer, said test taker computer and said happiness indicator test.

3. The system as in claim 1 wherein said server computer further comprises a web site storing said at least one happiness indicator test and comprising programming facilitating communication between said employer computer and said test taker computer.

4. The system as in claim 3, wherein said web site comprises programming:
A) for allowing an employer to purchase and store a plurality of said happiness indicator tests,
B) for allowing an employer to create a membership account,
C) for allowing a test taker to take at least one of said happiness indicator test, and
D) for reporting to said employer computer the results of said happiness indicator test taken by said test taker.
